(19) United States
(12) Patent Application Publication
(10) Pub. No.: US 2007/0184404 A1
(43) Pub. Date: Aug. 9, 2007

(54) Device For Cleaning And/Or The Care of Teeth And/Or Gums

(76) Inventor: Bernd J. Johnki, Borken (DE)

Correspondence Address: ST. ONGE STEWARD JOHNSTON & REENS, LLC, 986 BEDFORD STREET, STAMFORD, CT, 06905-5619, US

(21) Appl. No.: 11/735,296

(22) Filed: Apr. 13, 2007

Related U.S. Application Data
(63) Continuation of application No. PCT/EP05/10531, filed on Sep. 29, 2005.

(30) Foreign Application Priority Data
Oct. 13, 2004 (DE) 10 2004 049 950.0

(51) Int. Cl. A61C 17/02

(52) U.S. Cl. 433/80

(57) ABSTRACT

The invention relates to a device for cleaning and/or care of teeth and/or gums, said device comprising a molded spoon-shaped mouthpiece for an upper jaw and/or a lower jaw, provided with at least one channel ending in at least one nozzle for applying liquid to teeth and/or gums. The aim of the invention is to improve one such device for cleaning and/or care of teeth and/or gums, both in terms of the handling thereof and the obtainable cleaning and/or care effect on the teeth and/or gums, in such a way that effective and long-lasting cleaning and/or care of teeth and/or gums can be carried out in a more simple and comfortable manner, especially for people in need of care and confined to bed. To this end, the mouthpiece also comprises at least one channel ending in at least one opening, through which liquid applied to the teeth and/or gums can be essentially sucked out.

### CROSS-REFERENCE TO RELATED APPLICATIONS

The present application is a continuation of pending International patent application PCT/EP2005/010531 filed on Sept. 29, 2005 which designates the United States and claims priority from German patent application 10 2004 049 950.0 filed on Oct. 13, 2004, the content of which is incorporated herein by reference.

### FIELD OF THE INVENTION

The invention relates to a device for cleaning and/or care of teeth and/or gums, said device comprising a molded spoon-shaped mouthpiece for an upper jaw and/or a lower jaw, provided with at least one channel ending in at least one nozzle for applying liquid to teeth and/or gums. Such a device is described for instance in EP 0 865 770 A1.

### BACKGROUND OF THE INVENTION

Numerous devices for the care of teeth and gums are reported in the prior art.

DE 729 861, for instance, describes a rinsing device for teeth and oral membranes, which includes several tubes running along the row or arc of teeth on the inside and outside, which have numerous openings for configuring flushing jets of a rinsing liquid supplied to the tubes, and a funnel that presses itself against the mouth and serves to capture and divert rinsing liquid running out of the oral cavity. Because of the structural configuration of the rinsing device according to DE 729 861, an effective, thorough cleaning and/or care of teeth and/or gums can be obtained only in part. In addition the handling of the rinsing device according to DE 729 861 is extremely complex, difficult, and uncomfortable, in particular for people in need of care and confined to bed or lame persons or their caregivers, because safe and clean removal of rinsing liquid from the oral cavity is not possible by means of the funnel. It is therefore impossible for bed-ridden persons to use the cleaning device cleanly and comfortably.

Patent DE 43 40 598 A1 describes a method and a device for cleaning teeth. In this case a liquid and/or gaseous cleaning agent is applied to a peripheral area closed off from outside and including all teeth of an upper and/or lower jaw and is subjected to ultrasound. The peripheral area, closed off and insulated from outside, covering all teeth of an upper and/or lower jaw, is made up of a molded spoon-shaped mouthpiece for the upper and/or lower jaw. In the molded spoon-shaped mouthpiece for the upper and/or lower jaw, tubes or channels are configured along the rows of teeth to introduce cleaning agents to the inside or outside of the teeth. The channels are pierced by numerous slit-shaped openings, through which cleaning agent can be directed toward the teeth. The isolation of the peripheral area of the teeth, which is provided with cleaning material, in DE 43 40 598 A1, is essentially for the cleaning of teeth by ultrasound, which would otherwise not be provided. Because of the active principle of the ultrasound application, cleaning and/or care of the gums is not possible with the device according to DE 43 40 598 A1. The handling of the mouthpiece according to DE 43 40 598 A1 is uncomfortable and complex for people in need of care and especially those confined to bed or for lame persons or their caregivers, because after completion of the ultrasound application the cleaning agent applied to the mouthpiece must be removed from the oral cavity. Clean and comfortable use of the cleaning device with persons confined to bed is therefore likewise nearly impossible.

U.S. Pat. No. 5,443,386 describes a toothbrush that consists of a molded spoon-shaped mouthpiece for the upper and/or lower jaw. Brushes are dissolubly installed in the mouthpiece at various firmly predetermined positions. The teeth are cleaned by mechanical motion of the mouthpiece relative to the teeth. In addition the mouthpiece as inlet and outlet openings through which the liquid can be introduced or applied. The inlet openings for the liquid are arranged in the area of he brushes. Because of the structural design of the mouthpiece of the toothbrush according to U.S. Pat. No. 5,443,386, it is likewise nearly impossible to remove the liquid safely, cleanly, and comfortably, in particular for persons confined to bed or in lying position. In addition the cleaning that is possible with the toothbrush according to U.S. Pat. No. 5,443,386 is limited, especially because of the firmly predetermined positions of the brushes in the mouthpiece.

Patent EP 0 865 770 A1 describes a dental rinsing device for therapeutic treatment of teeth and/or dental care. The rinsing device consists of a molded spoon-shaped mouthpiece for the upper and/or lower jaw, which is provided with rinsing channels ending in nozzles. A therapeutic liquid is directed to the flushing channels and applied to the outer rows of teeth by means of the nozzles in the mouthpiece. Also in the rinsing device according to EP 0 865 770 A1safe, clean, and comfortable removal of the applied liquid is impossible because of the structural design, in particular for persons depending on care or assistance or those confined to bed. In addition the cleaning of teeth and/or gums that can be achieved with the rinsing device described in EP 0 865 770 A1 is severely limited or restricted because of the nozzle device.

In view of this state of the art, it is the aim of the invention to improve a device of the aforementioned type in respect of its handling as such and also the achievable cleaning and/or care of teeth and/or gums, in such a way that more effective and more lasting cleaning and/or care of teeth and/or gums can be carried out in a more simple and comfortable manner, especially for people in need of care and confined to bed.

### SUMMARY OF THE INVENTION

According to the invention, this aim is met with a device for cleaning and/or care of teeth and/or gums, said device comprising a molded spoon-shaped mouthpiece for an upper and/or lower jaw that includes at least one channel ending in at least one nozzle for applying liquid to the teeth and/or gums, in that the mouthpiece in addition comprises at least one channel ending in at lest one opening through which liquid applied to the teeth and/or gums can be essentially sucked out.

The invention reflects the recognition that, because of the possibility and functionality of sucking applied liquid out of the mouthpiece, the device can more easily be employed in a more comfortable and easier manner for the cleaning and/or care of teeth and/or gums for and/or by people in need of care and confined to bed, in particular without applied liquid or saliva of a person, either accidentally or deliberately, needing to be swallowed or spit out by the person. For this reason the mouthpiece of this invention advantageously makes it possible for the mouth to be closed or kept closed during the application for cleaning and/or care.

In an advantageous configuration of the invention, the mouthpiece can be positioned in the oral cavity so that it insulates teeth and/or gums from the oral cavity. In this way it is also ensured that liquid applied by means of the mouthpiece can only reach the area of the teeth and/or gums that is to be cleaned or cared for. The insulation from the oral cavity can be advantageously achieved and/or supported by evacuation, preferably by sucking out of applied liquid. In addition, besides applied liquid, saliva accumulating in the oral cavity and liquid possibly arriving in the oral cavity through leaks in the mouthpiece can also be sucked out by the mouthpiece, preferably through a suction opening configured as a pass-through hole in the base of the mouthpiece and extending into the free oral cavity.

In a preferred configuration of the invention the mouthpiece comprises a base running essentially parallel to the upper and/or lower jaw and essentially perpendicular to the base on the inside and outside along the teeth rows or arcs. The free ends of the side walls advantageously form a surrounding insulating rim, which preferably is contiguous with the inside and outside along the tooth rows or arcs surrounding the gums, that is, palatally and vestibularly or buccally with the upper jaw and lingually and vestibularly or buccally with the lower jaw.

In an advantageous configuration of the invention the channels and/or openings, for sucking out applied liquid in the base, are positioned in the side wall running along the tooth rows or arcs on the inside (palatally with the upper jaw or lingually with the lower jaw) and/or on the outside (vestibularly or buccally with the upper and/or lower jaw).

In another advantageous configuration of the invention the channels and/or nozzles for applying liquid to teeth and/or gums are positioned in the base, in the side wall running along the tooth rows in the inside (palatally with the upper jaw or lingually with the lower jaw) and/or in the side wall of the mouthpiece running along the tooth rows on the outside (vestibularly or buccally with the upper and/or lower jaw).

The openings of the nozzles are advantageously directed essentially to the surface of the tooth body of the teeth, so that teeth individually can be subjected completely and inclusively from all sides to cleaning and/or to care. The openings of the nozzles are advantageously directed essentially to the surfaces of the tooth body of the molars and/or of the front teeth (cutting and corner teeth [canines and incisors]). In another configuration of the invention the openings of the nozzles are directed essentially to the indentations (occlusal fissures) in the incisor surfaces of the molars (premolars, molars) and/or on the cutting edges (incisor surfaces or edges) of the front teeth (cutting and corner teeth [canine and incisive]). The openings of the nozzles, in another configuration of the invention, are advantageously directed to the visible tooth necks (cervical area). The openings of the nozzles are advantageously directed essentially to the space between two teeth, preferably essentially to the approximal, that is, the mesial and/or distal tooth side surfaces.

Advantageously, the openings of the nozzles in another advantageous configuration of the invention are directed essentially to the gum seam, preferably essentially to the approximal and/or interdental gum papillae, most preferably in the essential space between two teeth, so that the particular mesial and/or distal tooth side surfaces can be subjected with precision to cleaning and/or care.

An additional advantageous configuration of the invention is characterized by nozzles whose openings are essentially directed to the outside (vestibular or buccal) surfaces of the teeth, preferably forming an angle between the spraying direction of the nozzles and the idealized tooth axis of the teeth of about 30 degrees to the tip of the root (apically) of the teeth. Another advantageous configuration of the invention is characterized by nozzles whose surfaces are essentially directed to the inside (lingual and/or palatal) surfaces of the teeth, preferably forming an angle between the spraying direction of the nozzles and the idealized tooth axis of the teeth of about 15 degrees to the tip of the root (apically) of the teeth. The spraying direction of a nozzle, in keeping with the present invention, is thus the idealized main spraying direction of the nozzle.

The base of the mouthpiece, at least in the area of the front and/or side teeth, advantageously comprises knob-like protrusions and/or recesses to secure the bite. As a result the seating of a mouthpiece positioned in the oral cavity for cleaning and/or care of teeth and/or gums is as precisely positioned and immovable as possible. In addition the ease of application of the mouthpiece is thereby further improved.

The mouthpiece is advantageously made of latex, silicon, and/or rubber, preferably of soft silicon and/or silicon rubber. The mouthpiece can thus be positioned or inserted in the oral cavity more easily, comfortably, and in particular so as to avoid pressure points and the like and can be optimally contiguous to the gum, especially for purposes of insulation.

In a concrete embodiment of the invention the channels in the area lying in the proximity of the incisors lead out of the mouthpiece, preferably by means of a flange-like connector piece, which is most preferably configured on the mouthpiece.

In an especially advantageous configuration of the invention the channels or nozzles for applying liquid can be provided with liquid in cycles adjusted to one another or adapted to one another. The channels or nozzles for applying liquid can be alternatingly provided with liquid. The liquid can advantageously be applied in force impulses in order to intensify the cleaning and or care effect. In another advantageous configuration of the invention the liquid can be applied with predeterminable and/or individually adjustable pressure. In another preferred configuration of the invention, applied liquid can be continually sucked out, for which purpose the channels or the openings for sucking out applied liquid can continually be provided with a pressure (suction pressure) that lies below the ambient pressure of the mouthpiece. The pressure (suction pressure) lying below the ambient pressure of the mouthpiece can advantageously be individually adjusted, so that the seating of the mouthpiece in the oral cavity can be adjusted optimally and comfortably for cleaning and/or care applications.

By using the aforementioned individually directed nozzles or nozzle appliances and the various combined possibilities for applying liquid, it is possible to produce various cleaning and/or care models in combinations, which can advantageously be adjusted in particular to the individual cleaning and/or care requirements and/or wishes of the particular user.

Another especially advantageous configuration of the invention foresees that the application of liquid and/or the sucking out of applied liquid make use of a control device that can be connected with the channels in the mouthpiece and is programmable, preferably individually programmable.

In an especially preferred configuration of the invention the control device is programmable by means of cartridges of pre-apportioned application liquid and/or cartridges with application agents that are soluble with or in liquid, for instance in pulverous, gel, or tablet form of the like. With this configuration of the invention, one achieves a mechanical programming of the control device by means of the cartridges of pre-apportioned application liquid an/or cartridges with application agents that are soluble with or in liquid; thus, cleaning and/or care patterns foreseen for the use of the cleaning liquid found in each case in the cartridge are conducted by programmed control, for instance by means of notches and/or recesses on the housing of a cartridge. As a result, handling in particular is facilitated for the user and faulty operation with the particular application of the liquid is prevented.

The channels can advantageously be dissolubly combined with the control device by means of hoses, preferably by means of a rapid-closing coupling or comparable dissoluble connecting method, for instance a so-called “Sixtube” hose connection of the Colder Products Company.

In another advantageous configuration of the invention, the liquid contains mouth or tooth cleaning and/or treatment substances and/or tooth decay repair or tooth decay reinforcement materials, preferably in the form of nanoparticles or encapsulated microparticles. Such tooth cleaning or tooth care materials have been published for instance by patents GB 2 354 709 A, WO 01/89462 A2, or WO 02/17868 A1.

Another especially advantageous configuration of the invention relates to an inventive device for cleaning and/or care of teeth and/or gums in which the one molded spoon-shaped mouthpiece is adapted to the shape of the upper or lower jaw of a domestic animal, preferably a dog or cat. According to the invention in this manner it is possible to produce a device for cleaning and/or care of teeth and/or gums of domestic animals, preferably dogs or cats.

Further details, characteristics, and advantages of the invention are described more closely with reference to the illustrations.

### BRIEF DESCRIPTION OF THE DRAWINGS

FIG. 1 shows a schematically perspective view of an embodiment of a mouthpiece of a device according to the invention for cleaning and/or care of teeth and/or gums.

FIG. 2a shows a schematic side view of the mouthpiece of FIG. 1.

FIG. 2b shows a schematic view of the mouthpiece along the cutting line C-C of FIG. 2a.

FIG. 3a shows a schematic aerial view of the mouthpiece of FIG. 1.

FIG. 3b shows a cut-out view of the mouthpiece along the cutting line A-A of FIG. 3a.

FIG. 3c shows a cut-out view of the mouthpiece along the cutting line B-B of FIG. 3a.

FIG. 3d shows a cut-out view of the mouthpiece along the cutting line D-D according to FIG. 3a.

FIG. 3e shows a cut-out view of the mouthpiece along the cutting line E-E of FIG>3a.

FIG. 4a shows another schematic side view of the mouthpiece of FIG. 1.

FIG. 4b shows a cut-out view of the mouthpiece along the cutting line F-F of FIG. 4a.

FIG. 5 shows a theoretical embodiment for powering the various channels or nozzles for applying liquid to teeth and/or gums and the channels or openings for sucking out applied liquid of a cleaning and/or care cycle.

### DETAILED DESCRIPTION OF THE INVENTION

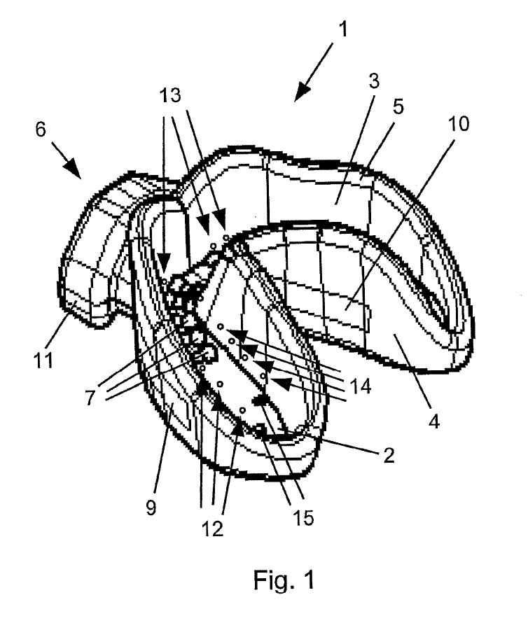

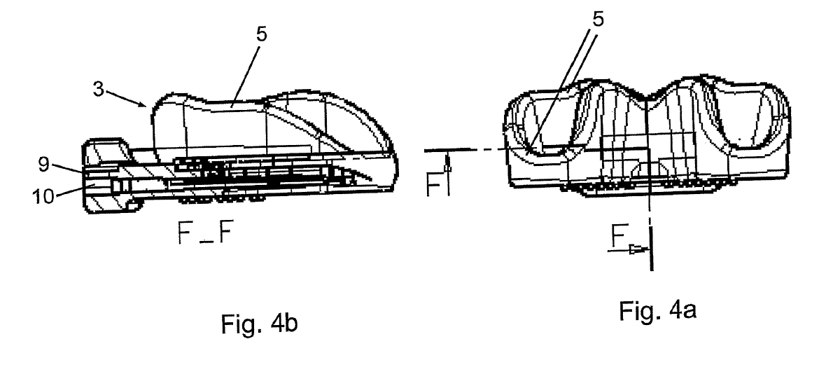

The mouthpiece 1 depicted in FIGS. 1 to 4b is constructed as an energy-passive element of soft silicon and can advantageously be produced in various sizes, for instance for children or adults, or adapted to individuals. The external form of the mouthpiece 1 is based on a dental casting spoon for the upper or lower jaw. The present illustrated mouthpiece 1 can be inserted in the oral cavity flexibly, that is, by turning 180 degrees to select or rotate among cleaning and/or care applications in the upper as well as lower jaw.

The mouthpiece 1 comprises a base 2 running essentially parallel to the upper and/or lower jaw, and side walls 3 and 4 running essentially perpendicular to the base 2 on the inside and outside along the tooth rows or arcs. The free ends of the side walls 3 and 4, that is, the rounded-off flanks when the mouthpiece 1 is inserted in the oral cavity as far as the oral mucous membrane, form a surrounding insulating rim 5, which for the upper jaw comes to rest in the surrounding fold of the oral vestibule in the area of the molar pockets and in the gum roof, and for the lower jaw comes to rest in the surrounding fold of the oral vestibule, in the area of the molar pockets and in the sub-lingual area.

The base 2 of the mouthpiece 1, on both its sides in the area of the front and side teeth, comprises knob-like protrusions 7 for improved fixing of the bite of the mouthpiece 1. The knob-like protrusions positioned on the inside of the mouthpiece 1 between the side walls 3 and 4 on the base, serve both for secure fixing of the bite of the mouthpiece 1 and also as a distance holder between tooth surfaces and the base 2 of the mouthpiece 1.

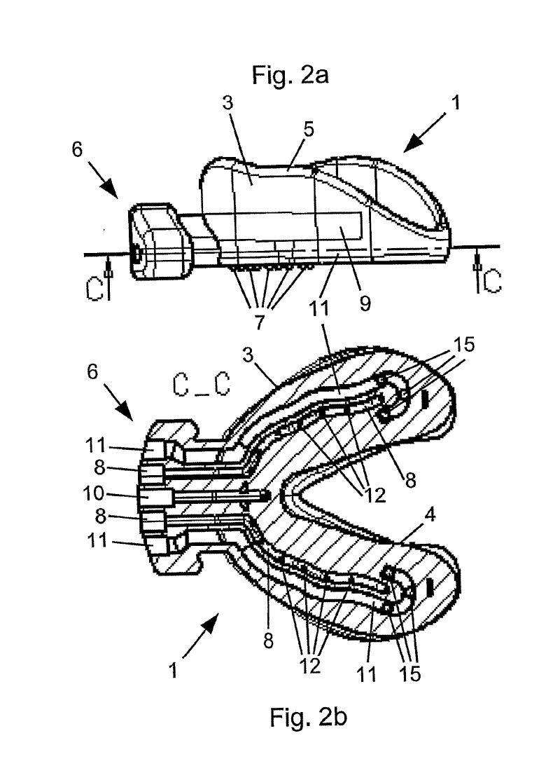

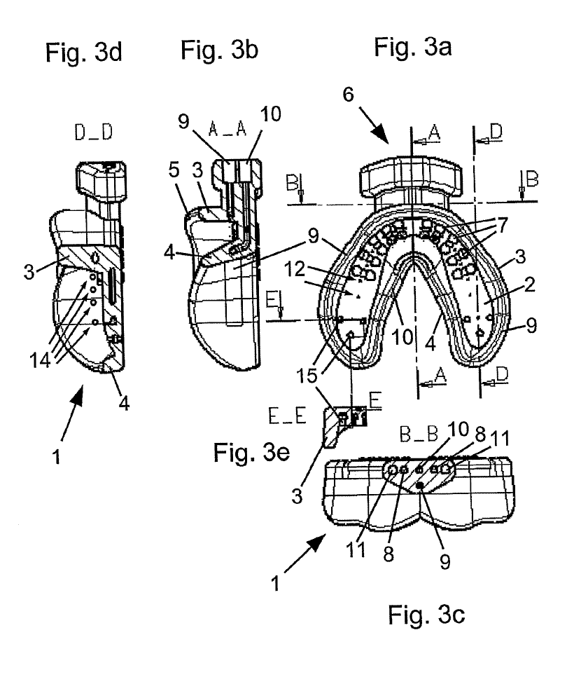

As can be recognized in particular from FIGS. 2b and 3a, channels 8 ending in nozzles 12 and channels 11 ending in openings 15 are positioned or configured in the base 2, channels 10 ending in nozzles 14 are positioned or configured in the inner side wall 4, and channels 9 ending in nozzles 13 in the outer side wall 3, all of which channels are conducted outward from the mouthpiece 1 by way of a flange-type connector piece 6 in the area lying in the area of the incisors.

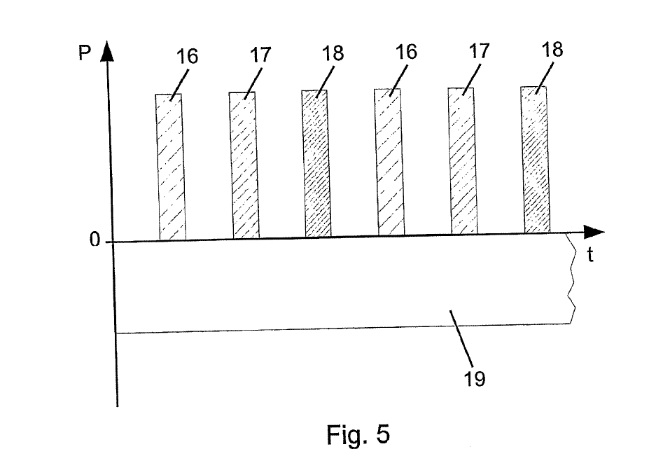

The two channels 11 in the base 2 of the mouthpiece 1 each comprises in the area coming to lie in the area of the molars three openings 15, which serve essentially to suck out applied liquid and/or leaked liquid or saliva. For the most part the openings 15 each have a diameter of about 2 mm. Through these openings the interior space of the mouthpiece that surrounds the teeth and gums is evacuated by suction, preferably permanent or continuous, as is shown in FIG. 5.

The two channels 8 in the base of the mouthpiece 1 predominantly have eight nozzles 12 each, arranged in a line along the tooth rows or arcs. The output openings of the nozzles 12 are essentially directed to the center of the imaginary tooth axis. The nozzles 12 of this line of nozzles serve predominantly to perform essentially the cleaning and/or care of the recesses (occlusive fissures) in the molar surfaces of the molars (premolars and molars) and the cutting edges (incisor surfaces or edges) of the front teeth (cutting and corner teeth [canines and incisors]) and, in addition, of the other surfaces of the tooth body of the molars and front teeth (cutting and corner teeth [canines and incisors]).

The two channels 9 in the outer side wall 3 of the mouthpiece 1 together comprise predominantly thirteen nozzles 13, which are positioned in a line along the outside (vestibular or buccal areas) of the tooth rows or arcs. As a rule the output openings of the nozzles 13 are essentially directed to the outside (vestibular or buccal) surfaces of the teeth and thus form an angle of about 30 degrees between the main flow direction of the nozzles 13 and the imaginary tooth axis of the teeth (alignment to the imaginary root tip [apically]). The nozzles 13 of this line of nozzles serve primarily essentially for a cleaning and/or care of the spaces between two teeth, in particular the approximal, that is, the mesial and/or distal tooth side surfaces, of the gum seam, the approximal and/or interdental gum papillae, in particular in the area between two teeth, and in addition the visible tooth necks (cervical area).

The two channels 10 in the inner side wall 4 of the mouthpiece 1 predominantly have seven nozzles 14 each, which are directed in a line along the inside (palatally in the upper jaw or lingually in the lower jaw) of the tooth rows or arcs. For the most part the outlet openings of the nozzles 14 are directed essentially to the inside (palatally in the upper jaw or lingually in the lower jaw) surfaces of the teeth and thus form an angle of about 15 degrees between the main flow direction of the nozzles 13 and the imaginary tooth axis of the teeth (alignment to the imaginary root peak [apically]). Primarily the nozzles 14 of this line of nozzles serve essentially for a cleaning or and/or care of the inside (lingual and/or palatal) surfaces of the teeth and of the gum seam, of the approximal and/or interdental gum papillae, and in particular in the space between two teeth, and in addition of the visible tooth necks (cervical area).

The orientation of the nozzles 12, 13, and 14 of the three nozzle lines primarily allows an extensive cleaning and/or care of the hard tissue of the teeth and gums, in particular because, owing to reflections of the applied liquid on the teeth and from combinations of spray and/or rinse streams, all areas of the teeth and gums can be subjected to a consistent, protective treatment.

An individually programmable control device, comprising a microcontroller, is provided for applying liquid an/or sucking out applied liquid. The programmable control device can also be configured to have purely hydraulic and/or pneumatic materials or components. The control device primarily includes at least one pump, which can be powered by the microcontroller or hydraulic and/or pneumatic materials or components according to the programming, for applying three different mutually adjusted treatment liquids. The treatment liquids are thus pumped out of a reserve tank provided for the particular treatment liquid. Here the channels 8, 9, and 10 are primarily activated repeatedly and cyclically with force impulses 16, 17, and 18 of the various treatment liquids, primarily in two cycles as can be seen in FIG. 5. The duration as well as the pressure of the force impulses 16, 17, and 18 can be predetermined. For the most part the duration as well as the pressure of the force impulses 16, 17, and 18 and the timed pauses between them are configured as equal. Instead of one pump for the various treatment liquids 16, 17, and 18, a separate pump can be provided alternatively also for each treatment liquid 16, 17, and 18.

The control device also includes primarily a pump for sucking treatment liquid out of the mouthpiece 1 through the openings 15 of the channels 11 in order to evacuate the mouthpiece 1. The pump is likewise powered by the microcontroller or hydraulic and/or pneumatic materials or components of the control device, according to the individual programming. For the most part, in the context of the treatment cycles, applied treatment liquid is sucked out of the mouthpiece 1 continually with an individually predetermined low pressure (suction pressure) with the pump, as can be seen in the curve of the suction pump designated with reference number 19 in FIG. 5. The sucked-out applied treatment liquid can then be disposed of directly in a drainage network or alternatively collected in a collection container for later disposal or treatment.

The individually programmable control device thus makes possible a precise cycling that can be reproduced at any time for cleaning and/or dental care treatment. The programming thus can be performed with cartridges with treatment liquid or with treatment material soluble in liquid, as well as advantageously by biometrical identification information of the particular user, such as fingerprints or the like.

The embodiments of the invention depicted in the illustrations serve merely to describe the invention and are not meant to restrict it.

1. A device for cleaning and/or care of teeth and/or gums, said device comprising a molded spoon-shaped mouthpiece for an upper jaw and/or a lower jaw, provided with at least one channel ending in at least one nozzle for applying liquid to teeth and/or gums characterized in that
the mouthpiece in addition comprises at least one channel ending in at least one opening, through which channel applied liquid can be essentially sucked out.

2. A device according to claim 1, characterized in that the mouthpiece can be positioned in the oral cavity so as to insulate teeth and/or gums from the moral cavity.

3. A device according to claim 2, characterized in that the insulation with respect to the oral cavity can be accomplished and/or supported by evacuation, preferably by sucking out applied liquid.

4. A device according to claim 1, characterized in that the mouthpiece comprises a base running essentially parallel to the upper and/or lower jaw and side walls running essentially perpendicular to the base on the inside and outside along the tooth rows.

5. A device according to claim 4, characterized in that the free ends of the side walls form a surrounding insulating rim.

6. A device according to claim 1, characterized in that the channels and/or openings for sucking out applied liquid are positioned in the base, in the side wall of the mouthpiece running on the inside along the tooth rows, and/or in the side wall of the mouthpiece running on the outside along the tooth rows.

7. A device according to claim 1, characterized in that the channels and/or nozzles for applying liquid to teeth and/or gums are positioned in the base, in the side wall of the mouthpiece running on the inside along the tooth rows, and/or in the side wall of the mouthpiece running on the outside along the tooth rows.

8. A device according to claim 1, characterized in that the openings of the nozzles are essentially directed to the surfaces of the tooth body of the teeth.

9. A device according to claim 1, characterized in that the openings of the nozzles are essentially directed to the surfaces of the tooth body of the molars and/or front teeth (cutting and corner teeth [canines and incisors]).

10. A device according to claim 1, characterized in that the openings of the nozzles are essentially directed to the recesses (occlusal fissures) in the chewing surfaces of the molars (premolars, molars) and/or to the cutting edges (incisor surfaces or edges) of the front teeth (cutting and corner teeth [canines and incisors]).

11. A device according to claim 1, characterized in that the openings of the nozzles are essentially directed to the visible tooth necks (cervical area).

12. A device according to claim 1, characterized in that the openings of the nozzles are essentially directed to the space between two teeth, preferably essentially to the approximal, that is, the mesial and/or distal tooth side surfaces.

13. A device according to claim 1, characterized in that the openings of the nozzles are essentially directed to the gum seam, preferably essentially to the approximal and/or interdental gum papillae, especially preferably essentially to the space between two teeth.

14. A device according to claim 1, characterized by nozzles whose openings are essentially directed to the outside (vestibular or buccal) surfaces of the teeth, preferably forming an angle of about 30 degrees between the flow direction of the nozzles and the imaginary tooth axis of the teeth to the root peak (apically) of the teeth.

15. A device according to claim 1, characterized by nozzles whose surfaces are essentially directed to the inside (lingual and/or palatal) surfaces of the teeth, preferably forming an angle of about 15 degrees between the flow direction of the nozzles and the imaginary tooth axis of the teeth to the root peak (apically) of the teeth.

16. A device according to claim 1, characterized in that the base of the mouthpiece, at least in the area of the front and/or side teeth, comprises knob-like protrusions and/or recesses for fixing the bite.

17. A device according to claim 1, characterized in that the mouthpiece is made of latex, silicon, and/or rubber, preferably from soft silicon and/or silicon rubber.

18. A device according to claim 1, characterized in that the channels in the area lying in the area of the cutting teeth are conducted out of the mouthpiece, preferably by a flange-type connector piece.

19. A device according to claim 1, characterized in that the channels or nozzles for applying liquid can be provided with liquid in cycles adjusted to one another or adapted to one another.

20. A device according to claim 19, characterized in that the channels or nozzles can be provided with liquid alternatingly for applying liquid.

21. A device according to claim 19, characterized in that the liquid can be applied in force impulses.

22. A device according to claim 1, characterized in that the liquid can be applied with predetermined and/or individually adjusted pressure.

23. A device according to claim 1, characterized in that applied liquid can be continuously sucked out, for which purpose the channels or openings can be continuously provided with a pressure (suction pressure) to suck out applied liquid, said suction pressure lying below the ambient pressure of the mouthpiece.

24. A device according to claim 23, characterized in that the pressure (suction pressure) lying below the ambient pressure of the mouthpiece can be individually adjusted.

25. A device according to claim 1, characterized in that the application of liquid and/or the sucking out of applied liquid is accomplished by means of a control device that can be connected with the channels in the mouthpiece and can be programmed, preferably individually programmed.

26. A device according to claim 25, characterized in that the control device can be programmed by means of cartridges of pre-portioned application liquid and/or cartridges with application materials that are soluble with liquid or in liquid.

27. A device according to claim 1, characterized in that the channels can be dissolubly connected with the control device by hoses, preferably by means of a quick-locking coupling.

28. A device according to claim 1, characterized in that the liquid contains mouth or tooth cleansing and/or care substances and/or tooth decay repair or tooth decay reinforcement substances, preferably in the form of nanoparticles or encapsulated microparticles.

29. A device according to claim 1, characterized in that the molded spoon-shaped mouthpiece is adapted in terms of shape
